(19) United States
(12) Patent Application Publication
(10) Pub. No.: US 2019/0132469 A1
(43) Pub. Date: May 2, 2019

(54) SCANNING WITH DESTINATION MARKS

(71) Applicant: Hewlett-Packard Development Company, L.P., Houston, TX (US)

(72) Inventor: John Michael Heineck, Boise, ID (US)

(21) Appl. No.: 16/093,435

(22) PCT Filed: Jul. 7, 2016
(86) PCT No.: PCT/US2016/041358

§ 371 Date: Oct. 12, 2018

(51) Int. Cl. H04N 1/00; H04N 1/40

(52) U.S. Cl. CPC H04N 1/00968; H04N 1/40; H04N 1/00225

(57) ABSTRACT

Example Implementations relate to scanning with destination marks. For example, a system according to the present disclosure, may include a computing network including a plurality of destination points, and a scanning device coupled to the computing network. The scanning device may receive a first destination mark and first document settings associated with the first destination mark, as well as first destination instructions associated with the first destination mark. The scanning device may send a first scanned document having the first document settings to a first destination point among the plurality of destination points, in accordance with the first destination instructions and in response to identification of the first destination mark on the first scanned document.

### BACKGROUND

Scanning devices may enable scanned objects, such as documents, to be sent to various locations. Such devices may also allow for the selection and/or definition of various options. In order for a user to send a communication by fax machine, the user must either input the fax number using a numeric control panel, or press a hot key on a control panel for that particular fax number. In either case, the user must know the communication address or number for the location where the document is to be sent. Likewise, when using e-mail, the user may rely upon an e-mail software application that allows the user to type in an e-mail address or automatically reply to an e-mail and send the reply to one or more locations.

### BRIEF DESCRIPTION OF THE DRAWINGS

FIG. 1 illustrates a diagram of a system for scanning with destination marks, according to the present disclosure.

FIG. 2 is an example illustration of a document including a plurality of destination marks, according to the present disclosure.

FIG. 3 is a block diagram of an example system for scanning with destination marks, according to the present disclosure.

FIG. 4 illustrates an example method for scanning with destination marks, according to the present disclosure.

### DETAILED DESCRIPTION

When scanning, a user may have a vast number of options to select. For instance, the user may have selectable options in terms of a scan-to-destination, a resolution, a brightness and/or contrast, and whether the document should be scanned in duplex form or simplex form, among other examples. When selecting these options, such as deciding a destination for the scanned document, the user must manually enter in information, such as email address or network folder name, among other examples. This may be a tedious process, especially when performing repeated scan jobs.

In contrast, scanning with destination marks, in accordance with the present disclosure, may allow a user to automatically send a scan job to a particular destination point, and with certain settings, with minimal manual input, thereby saving time and improving the user experience. As described further herein, scanning documents with destination marks may be detected on a scanned document, and the scanned image may be automatically sent to a particular destination point, based on various characteristics of the destination mark.

As used herein, a “destination mark” refers to a mark that identifies a destination point where scanned documents should be sent, and settings that should be applied to the scanned document. A “destination point” refers to a location, physical and/or virtual, that may receive a scanned image. The destination point may be a folder, such as a network folder, an email address, a fax number, and/or a server location, among other examples. The destination point may be an internal location, such as within a private network, or an external location, such as an address within the Internet and/or a public cloud. Put another way, the destination point associated with a destination mark may be any location to which a scanning device is capable of sending a scanned document and/or image to.

For simplicity purposes, the present disclosure refers to scanning “documents”, though examples are not so limited. An image or other object may be scanned and transmitted in accordance with the present disclosure. Put another way, the processes described herein may be applied to any document, object, scenery, or other environment that may be scanned by a scanning device.

Further, as used herein, a “setting” or “settings” may refer to a setting that is configurable on the scanning device and may be applied to the scanned image. Examples of settings may include an image resolution, an image contrast, and a designation of simplex or duplex form, among other examples discussed herein.

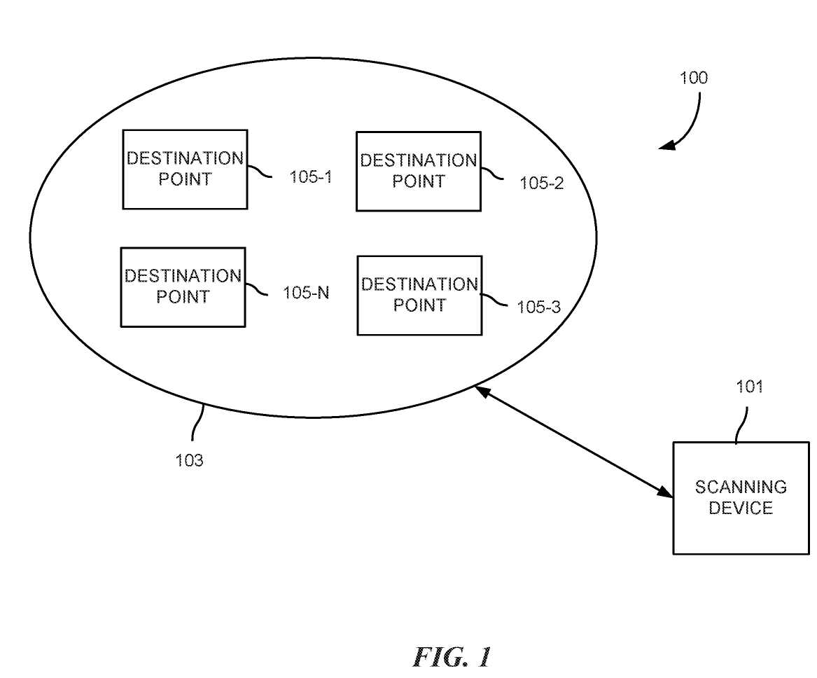

FIG. 1 illustrates a diagram of a system 100 for scanning with destination marks, according to the present disclosure. As illustrated in FIG. 1, the system 100 may comprise a computing network 103 including a plurality of destination points 105-1, 105-2, 105-3, . . . 105-N (referred to collectively as “destination points 105”). As described herein, a “destination point” refers to a location where a scanned document may be sent. Although FIG. 1 illustrates four destination points 105, examples of the present disclosure may include more or fewer destination points than illustrated. Further, although destination points 105 are illustrated as being within computing network 103, examples are not so limited. For instance, some destination points among destination points 105 may be located within the computer network 103, and some destination points among the destination points 105 may be located outside of the computer network 103. For instance, destination point 105-1 may be located within computer network 103, whereas destination point 105-3 may be located outside of computer network 103. Furthermore, although each of destination points 105 are illustrated in a same manner as each of the other destination points, it is noted that destination points 105 may each be of a different type. For instance, destination point 105-1 may be a network folder, destination point 105-2 may be an email address, destination point 105-3 may be a uniform resource locator (URL) for a cloud, and destination point 105-N may be a fax number. Further, as discussed herein, the destination points 105 may be added, deleted, and/or modified by users based on the addition, deletion, and/or modification of destination marks.

The system 100 may further include a scanning device coupled to the computing network 103. The scanning device 101 may receive destination marks, as well as associated information. As described herein, a destination mark may be detected based on a shape, a color, and/or a position of the destination mark, among other examples. As such, a user may proceed through a setup process in which the destination mark is identified, and the destination point, destination points, and/or settings may be defined.

After the initial setup, a user may draw, generate, and/or print the destination mark on media to be scanned. After the setup process is complete, and a destination mark is defined, any time a user would like to scan with certain settings and/or destination points, the user may mark the document with the destination mark and scan the document, without going through the full scan setup process.

As described herein, destination marks may be user configurable, such that the user may draw or otherwise create their own destination mark. For instance, a first user may create a first destination mark having a red colored slash or X mark, while a second user may create a second destination mark having a green smiley face. Such destination marks may be hand drawn and/or computer generated.

For example, a destination mark may be provided by a user, a destination point or destination points may be provided by the user, and a setting or settings may be provided by the user. For instance, the scanning device 101 may receive a first destination mark, such as a blue ‘X’ mark, and first document settings associated with the first destination mark, such as settings indicating that the scanned image should be in color and in duplex form. The scanning device 101 may receive first destination instructions associated with the first destination mark, such as instructions to send the scanned image in color and in duplex form to destination point 105-1. Once a document is scanned by scanning device 101 that includes the first destination mark, e.g., the blue X, then the scanning device 101 may send the scanned document having the first document settings to the destination point, e.g., a first destination point among the plurality of destination points, in accordance with the first destination instructions and in response to identification of the first destination mark on the first scanned document.

Scanning with destination marks, in accordance with the present disclosure, may allow a user to quickly and accurately send a scanned document or a plurality of scanned documents to a particular destination or a plurality of destinations, and with defined settings. For instance, a user may place a stack of documents into a document feeder, where the stack of documents includes different destination marks throughout the stack, and the documents in the stack may be sent to different locations. Also, a user may have multiple destination marks on a single document in order to send that document to multiple destination points. Moreover, standardized destination marks may be used, such that documents shared between different parties may include at least some of the same settings and/or destination points. For instance, the symbol %F% may mean “send to folder:” and may be followed by a folder location. In such examples, users in different locations may make modifications to a same document and send the document to the same folder.

The scanning device 101 may receive a second destination mark and second document settings associated with the second destination mark, receive second destination instructions associated with the second destination mark. For instance, a user may create a separate destination mark, e.g., different than the first destination mark, such as a yellow star. The yellow star may be associated with second document settings that may be different than the first document settings. For instance, the second document settings may specify that documents should be scanned with low resolution and in black and white, among other examples. The yellow star may be associated with destination point 105-N, such that any documents having a yellow star may be sent to 105-N with low resolution and black and white ink print. As such, upon identification of the second destination mark, the scanning device 101 may send the second scanned document having the second document settings to a second destination point among the plurality of destination points, in accordance with the second destination instructions and in response to identification of the second destination mark on the second scanned document. That is, upon recognition of the yellow star on the document, scanning device 101 may send the scanned document to destination point 105-N with low resolution and in black and white. Furthermore, the scanning device may send the first scanned document having the second document settings to the second destination point, in response to identification of the second destination mark on the first scanned document. For instance, if a document included the first destination mark, e.g., the blue X, and the second destination mark, e.g., the yellow star, then the scanning device 101 may send a copy of the scanned document to destination point 105-1 in duplex form and in color, in accordance with the first destination mark, and a copy of the scanned document to destination point 105-N in black and white and with low resolution, in accordance with the second destination mark.

While examples of destination marks have been provided herein, generally describing destination marks in terms of shape and color, examples are not so limited. In some examples, the scanning device 101 may to identify the first destination mark and the second destination mark based on a shape, a color, or a location of the respective destination mark. For instance, a destination mark may be recognized by the scanning device 101 by its location on a document, such as in the bottom margin of the document, or in the background of an image, among other examples.

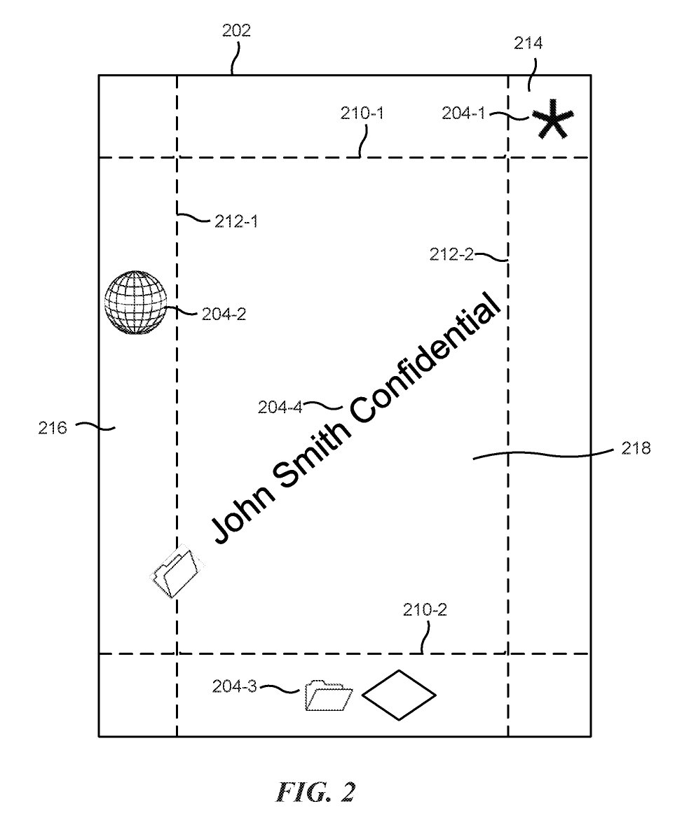

FIG. 2 is an example illustration of a document 202 including a plurality of destination marks, according to the present disclosure. As described in relation to FIG. 1, destination marks may vary, destination marks may be user-configurable and/or computer generated, and destination marks may be located in a plurality of locations.

For example, document 202 may include some of, or all of, destination marks 204-1, 204-2, 204-3, and 204-4 (collectively referred to herein as “destination marks 204). Each of the destination marks 204 may have a different appearance, and may have different settings associated with them. For instance, destination mark 204-1 may appear as an asterisk, and may be associated with instructions to scan the document 202 as a joint photograph experts group (JPEG) file, and send the file to a designated JPEG file folder in a network. In another example, destination mark 204-2 may appear as a globe, and may be associated with instructions to scan the document 202 as a portable document format (PDF), and send the file to a global email distribution list. Furthermore, destination mark 204-3 may appear as a file folder followed by a diamond, and may be associated with instructions to send the scanned document to a particular folder in a network, where the folder is identifiable by a diamond icon. Moreover, destination mark 204-4 may appear as a file folder followed by the words “John Smith Confidential”. Destination mark 204-4 may be associated with instructions to send the scanned document to a file folder associated with John Smith, and the document may be marked as “confidential”, indicating that it is password protected, or protected by other encryption techniques.

Further, each of the destination marks 204 may be located in a different place on the document 202. For instance, document 202 may be defined by a top margin 210-1, a bottom margin 210-2, a left margin 212-1, and a right margin 212-2. Regions within the document 202 may be defined by the margins. For instance, region 214 may include the right upper corner of the document 202, defined on the bottom by top margin 210-1, and on the left by right margin 212-2. Another region may be the entire right side of document 202, defined on the left by right margin 212-2. Similarly, a center region 218 may be defined by each of top margin 210-1, bottom margin 210-2, left margin 212-1, and right margin 212-2. Similarly, region 216 may be defined on the right by left margin 212-1, on the top by top margin 210-1, and on the bottom by bottom margin 210-2. As such, a plurality of different regions may be defined within document 202. As illustrated in FIG. 2, destination marks 204 may be disposed within different regions of the document 202. For instance, destination mark 204-1 may be disposed within region 214, whereas destination mark 204-2 may be disposed within region 216. In some examples, a destination mark may be disposed over a plurality of regions. For instance, destination mark 204-4 may be disposed over the center region 218, and region 216, among others. Put another way, destination marks may be located in a variety of locations, and the location may be specific to that particular destination mark.

While FIG. 2 illustrates document 202 as having a plurality of destination marks 204, it should be noted that some or all of those destination marks may be used. For instance, destination mark 204-1 may be used in addition to destination mark 204-2. Alternatively, destination mark 204-4 may be the only destination mark included. Also, notably, each destination mark identified on a document may be isolated and stripped from the final scanned document. For example, document 202 may include content to be scanned, copied, and/or transmitted to an intended recipient and/or location, but the final scanned document would not include any destination marks. Put another way, if document 202 were scanned, destination marks 204-3 and 204-1 were identified, e.g., included in the scanned image, destination marks 204-3 and 204-1 would be removed from the final scanned document.

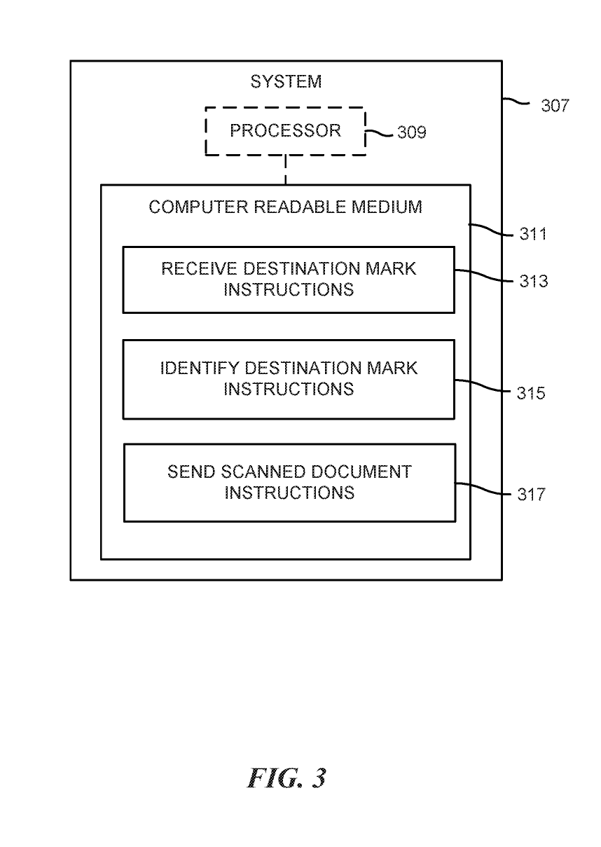

FIG. 3 is a block diagram of an example system 307 scanning with destination marks, according to the present disclosure. System 307 may be the same as or different than, system 100 illustrated in FIG. 1. System 307 may include at least one computing device that is capable of communicating with at least one remote system. In the example of FIG. 3, system 307 includes a processor 309 and a computer-readable medium 311. Although the following descriptions refer to a single processor and a single computer-readable medium, the descriptions may also apply to a system with multiple processors and computer-readable mediums. In such examples, the instructions may be distributed (e.g., stored) across multiple computer-readable mediums and the instructions may be distributed (e.g., executed by) across multiple processors.

Processor 309 may be one or more central processing units (CPUs), microprocessors, and/or other hardware devices suitable for retrieval and execution of instructions stored in computer-readable medium 311. In the particular example shown in FIG. 3, processor 309 may receive, determine, and send instructions 313, 315, and 317 for scanning with destination marks. As an alternative or in addition to retrieving and executing instructions, processor 309 may include one or more electronic circuits comprising a number of electronic components for performing the functionality of one or more of the instructions in computer-readable medium 311. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Computer-readable medium 311 may be any electronic, magnetic, optical, or other physical storage device that stores executable instructions. Thus, computer-readable medium 311 may be, for example, Random Access Memory (RAM), an Electrically-Erasable Programmable Read-Only Memory (EEPROM), a storage drive, an optical disc, and the like. Computer-readable medium 311 may be disposed within system 307, as shown in FIG. 3. In this situation, the executable instructions may be “installed” on the system 307. Additionally and/or alternatively, computer-readable medium 311 may be a portable, external or remote storage medium, for example, that allows system 307 to download the instructions from the portable/external/remote storage medium. In this situation, the executable instructions may be part of an “installation package”. As described herein, computer-readable medium 311 may be encoded with executable instructions for scanning with destination marks.

Referring to FIG. 3, receive destination mark instructions 313, when executed by a processor (e.g., 309), may cause system 307 to receive a plurality of destination marks, wherein each destination mark defines a respective destination point within a computing network and a respective document setting to be applied. For instance, as described with regard to FIG. 1, a destination mark may be generated by a user manually, or with the assistance of a computing device. A scanning device such as scanning device 101 in FIG. 1, may receive the destination mark, settings, and destination instructions to be applied.

Identify destination mark instructions 315, when executed by a processor (e.g., 309), may cause system 307 to identify a destination mark among the plurality of destination marks on a scanned document. That is, a destination mark or a plurality of destination marks may be identified on a scanned document. The destination mark may be identified using any form of scanning device, such as an all-in-one printer/scanner, a tablet computing device, a phone, and/or a scanner, among other devices. As described herein, the destination mark or destination marks may be identified based on shape, color, location, and/or any combination thereof. Moreover, the destination mark or destination marks may be identified using optical character recognition and/or other character recognition instructions.

Send scanned document instructions 317, when executed by a processor (e.g., 309), may cause system 307 to send a copy of the scanned document to the destination point associated with the destination mark and with the respective document setting applied, in response to the identification of the destination mark. As discussed in relation to FIG. 1, a single document may include multiple destination marks and therefore be sent to multiple destinations, each with different settings. As such, the processor 309 may execute instructions stored in computer-readable medium 311 to identify a second destination mark among the plurality of destination marks on the scanned document and send a copy of the scanned document to a different respective destination point with a different respective document setting applied. For instance, referring to FIG. 1, the document may be sent to destination point 105-2 as well as destination point 105-3. In some examples, the processor 309 may execute instructions stored in computer-readable medium 311 to generate a final scanned image by removing the identified destination mark from the scanned image of the scanned document, as described in relation to FIG. 3. In such examples, the instructions to send the copy of the scanned document to the destination point may include instructions to send the final scanned image to the destination point.

In some examples, the processor 309 may execute instructions stored in computer-readable medium 311 to receive a plurality of scanned documents, such as from an automatic document feed. In such examples, for each scanned document among the plurality of scanned documents, the processor 309 may identify a destination mark among the plurality of destination marks, and identify the destination point and the document setting of the scanned document based on the identified destination mark. For example, a plurality of documents may be scanned by a scanning device, and any destination marks on the documents may be identified. Some documents may not have any destination mark in which case the document may be sent to a default location with default settings. Other documents in the stack may have one destination mark and yet other documents may have a plurality of destination marks. Each document may be different, and may be processed according to the respective destination mark.

In some examples, the processor 309 may execute instructions stored in computer-readable medium 311 to receive a new user-generated destination mark, receive a new document setting and a new destination point associated with the new user-generated destination mark, and add the new user-generated destination mark to the plurality of destination marks. For example, all destination marks and their associated settings and destination instructions may be saved in a database. Saved destination marks may be added, removed, and/or modified. In such examples, a “new” destination mark refers to a destination mark that differs in appearance, location, settings, and/or destination instructions from any other saved destination mark. Destination marks may be saved on the device itself, such as device 101, or on another network connected device, such as a server.

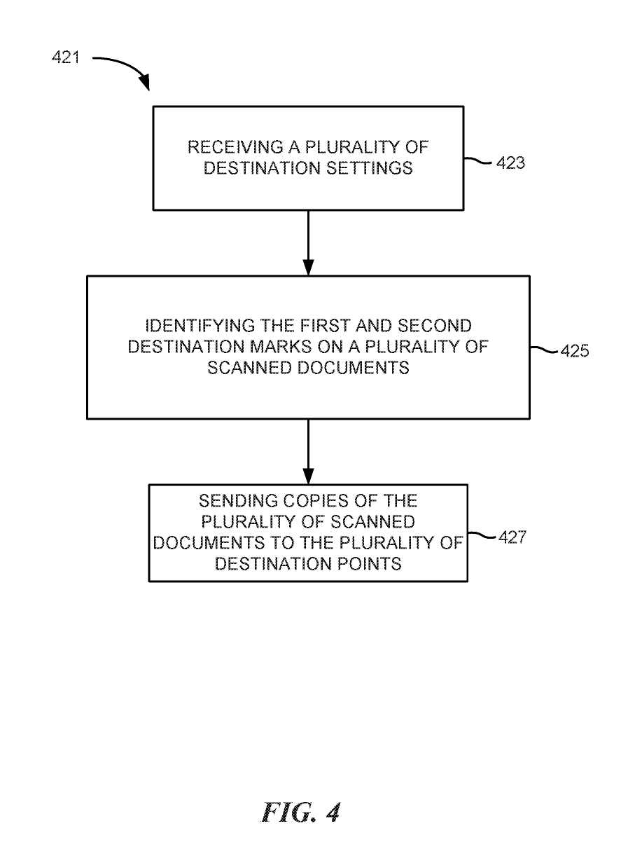

FIG. 4 illustrates an example method 421 for scanning with destination marks, according to the present disclosure. At 423, the method 421 may include receiving a plurality of destination settings associated with each of a first destination mark and a second destination mark. For instance, as described with regard to FIGS. 1 and 2, users may specify what a destination mark looks like, where it is located on a document, what settings should be applied to documents including the associated mark, and where they should be sent.

At 425, the method 421 may include identifying the first and second destination marks on a plurality of scanned documents. For instance, a user may place a stack, e.g., a plurality, of documents into a document feeder, where the stack of documents includes different destination marks throughout the stack. A destination mark may be identified on each of the documents, and the documents in the stack may be sent to different locations according to the associated destination marks.

At 427, the method 421 may include sending copies of the plurality of scanned documents to a plurality of destination points based on the identification of the first and second destination marks. For instance, as described in relation to FIG. 1, documents may be sent to destination points 105, illustrated in FIG. 1, based on which, if any, destination marks are identified on the respective scanned document. As such, the method 421 may include receiving first destination instructions associated with the first destination mark, where the first destination instructions direct a copy of a scanned document including the first destination mark to be sent to a first destination point. Moreover, the method 421 may include receiving second destination instructions associated with the second destination mark, where the second destination instructions direct a copy of a scanned document including the second destination mark to be sent to a second destination point.

Furthermore, as discussed in relation to FIGS. 1 and 2, identifying the first and second destination marks may include identifying the first destination mark or the second destination mark based on a shape, a color, or a position of a mark on a document among the plurality of scanned document, among other examples.

As described in relation to FIGS. 1 and 2, the method 421 may also include receiving first document settings associated with the first destination mark, and receiving second document settings associated with the second destination mark. That is, settings may be defined for each destination mark, defining what document options may be applied to the document being scanned.

Also, sending copies of the plurality of scanned documents to the plurality of destination points may include sending the copies to the plurality of destination points with the first document settings and second document settings applied. For instance, each scanned document sent to each destination point, may have the settings applied that are associated with the relevant destination mark. As described herein, settings applied to the scanned document may vary, and may include a document resolution, a document contrast, a file format, a type of compression, a privacy level, or a document size, among other settings defined by the scanning device.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designator “N”, particularly with respect to reference numerals in the drawings, indicates that a number of the particular feature so designated can be included with examples of the present disclosure. The designators can represent the same or different numbers of the particular features. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A system comprising:
a computing network including a plurality of destination points; and
a scanning device coupled to the computing network, the scanning device to:
receive a first destination mark and first document settings associated with the first destination mark;
receive first destination instructions associated with the first destination mark; and
send a first scanned document having the first document settings to a first destination point among the plurality of destination points, in accordance with the first destination instructions and in response to identification of the first destination mark on the first scanned document.

2. The system of claim 1, the scanning device to:
receive a second destination mark and second document settings associated with the second destination mark;
receive second destination instructions associated with the second destination mark; and
send a second scanned document having the second document settings to a second destination point among the plurality of destination points, in accordance with the second destination instructions and in response to identification of the second destination mark on the second scanned document.

3. The system of claim 2, the scanning device to:
send the first scanned document having the second document settings to the second destination point, in response to identification of the second destination mark on the first scanned document.

4. The system of claim 1, the scanning device to identify the first destination mark and the second destination mark based on a shape, a color, or a location of the respective destination mark.

5. A non-transitory computer readable medium containing instructions executable by a processor to:
receive a plurality of destination marks, wherein each destination mark defines a respective destination point within a computing network and a respective document setting to be applied;
identify a destination mark among the plurality of destination marks on a scanned document; and
send a copy of the scanned document to the destination point associated with the destination mark and with the respective document setting applied, in response to the identification of the destination mark.

6. The non-transitory computer readable medium of claim 5 wherein the destination mark is a first destination mark, further comprising instructions to:
identify a second destination mark among the plurality of destination marks on the scanned document; and
send a copy of the scanned document to a different respective destination point with a different respective document setting applied.

7. The non-transitory computer readable medium of claim 5, further comprising instructions to:
receive a plurality of scanned documents from an automatic document feed, the plurality of documents including the scanned document; and
for each scanned document among the plurality of scanned documents:
identify a destination mark among the plurality of destination marks; and
identify the destination point and the document setting of the scanned document based on the identified destination mark.

8. The non-transitory computer readable medium of claim 5, including instructions executable by the processor to:
receive a new user-generated destination mark;
receive a new document setting and a new destination point associated with the new user-generated destination mark; and
add the new user-generated destination mark to the plurality of destination marks.

9. The non-transitory computer readable medium of claim 5, including instructions executable by the processor to:
generate a final scanned image by removing the identified destination mark from a scanned image of the scanned document;
wherein the instructions to send the copy of the scanned document to the destination point include instructions to send the final scanned image to the destination point.

10. A method comprising:
receiving a plurality of destination settings associated with each of a first destination mark and a second destination mark;
identifying the first and second destination marks on a plurality of scanned documents; and
sending copies of the plurality of scanned documents to a plurality of destination points based on the identification of the first and second destination marks.

11. The method of claim 10, wherein identifying the first and second destination marks includes:
identifying the first destination mark or the second destination mark based on a shape, a color, or a position of a mark on a document among the plurality of scanned document.

12. The method of claim 10, further comprising receiving first destination instructions associated with the first destination mark, wherein the first destination instructions direct a copy of a scanned document including the first destination mark to be sent to a first destination point; and
receiving second destination instructions associated with the second destination mark, wherein the second destination instructions direct a copy of a scanned document including the second destination mark to be sent to a second destination point.

13. The method of claim 10, further comprising:
receiving first document settings associated with the first destination mark; and
receiving second document settings associated with the second destination mark.

14. The method of claim 13, wherein sending copies of the plurality of scanned documents to the plurality of destination points includes:
sending the copies to the plurality of destination points with the first document settings and second document settings applied.

15. The method of claim 13, wherein each of the first document settings and the second document settings include:
a document resolution;
a document contrast;
a file format;
a type of compression;
a privacy level; or
a document size.
